(19) United States
(12) Patent Application Publication
(10) Pub. No.: US 2017/0208354 A1
(43) Pub. Date: Jul. 20, 2017

(54) System and Method for Video Data Manipulation

(71) Applicant: Hi Pablo Inc., New York, NY (US)

(72) Inventor: Karim Michel NAZIR MORCOS, Cairo (EG)

(73) Assignee: Hi Pablo Inc

(21) Appl. No.: 15/406,965

(22) Filed: Jan. 16, 2017

Related U.S. Application Data
(60) Provisional application No. 62/279,552, filed on Jan. 15, 2016.

(51) Int. Cl. H04N 21/2743; H04N 21/61; H04N 21/44; H04L 29/08; H04N 21/4788; G06K 9/00; H04N 21/4402; H04N 21/488

(52) U.S. Cl. CPC H04N 21/2743; H04N 21/4402; H04N 21/6175; H04N 21/4882; H04L 67/26; H04N 21/4788; G06K 9/00758; H04N 21/44008

(57) ABSTRACT

A system and method for video processing in which video data is manipulated to provide an aesthetic effect, termed herein “light painting”.

### FIELD OF THE INVENTION

The present invention relates, in at least some embodiments, to a system and method for video processing and in particular, to such a system and method in which video data is manipulated for an aesthetic effect.

### BACKGROUND OF THE INVENTION

Mobile video is a very popular way to capture video data. Video data can be captured in other ways as well. However this video data is difficult to manipulate on mobile devices. In particular, filters and other aesthetic effects are not readily applicable to video captured on video devices, in contrast to the availability of such effects for photographs, for example through Instagram and other online services.

### SUMMARY OF THE INVENTION

None of the above described background art teaches or suggests a system and method for video processing in which video data is manipulated to provide an aesthetic effect.

The present invention, in at least some embodiments, overcomes these drawbacks of the background art by providing a system and method for video processing in which video data is manipulated to provide an aesthetic effect, termed herein “light painting”.

The method optionally operates to overwrite each pixel of a video frame with the highest intensity value for that pixel when comparing the pixels of the current frame to intensity of pixels of the preceding frames. Optionally the method operates as follows.

Optionally the method may be altered according to some other comparative value—rather than intensity, or in addition to intensity, optionally RGB values or other component values may be used, low intensity (as opposed to high intensity) or a combination thereof.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), a thin client, a mobile communication device, a smart watch or other wearable that is able to communicate externally, or a pager. Any two or more of such devices in communication with each other may optionally comprise a “computer network”.

### BRIEF DESCRIPTION OF THE DRAWINGS

FIG. 1 shows a non-limiting example of a system for sharing and manipulating image data according to at least some embodiments of the present invention;

FIG. 2 is an exemplary non-limiting implementation of internal modules of application software 102 according to at least some embodiments of the present invention;

FIG. 3 shows the different components of server engine 300 which is being run on application server 104;

FIGS. 4A and 4B show a non-limiting exemplary process which describes what happens at launch of the app (software according to at least some embodiments of the present invention);

FIG. 5 shows an exemplary non-limiting menu 500, featuring the main menu pages in the application;

FIG. 6 is the feed screen 600;

FIG. 7 shows an exemplary method to view the user profile of the user or another user;

FIG. 8 shows an exemplary non-limiting search screen and process;

FIG. 9 explains the social interactions in more detail;

FIG. 10 shows a non-limiting example of the More screen, which has more preferences and settings;

FIG. 11 is an exemplary non-limiting process that shows how light painting works from the point of view of the user, including actions taken by the user to light paint the video to manipulate that video data;

FIG. 12 is an exemplary non-limiting method for the last process in the camera module in which the image and/or video is prepared ready to be published;

FIGS. 13A and 13B show exemplary non-limiting methods for how the light painting algorithm itself works; and

FIG. 14 shows a different version of the light painting algorithm in an exemplary non-limiting embodiment according to the present invention.

### DESCRIPTION OF AT LEAST SOME EMBODIMENTS

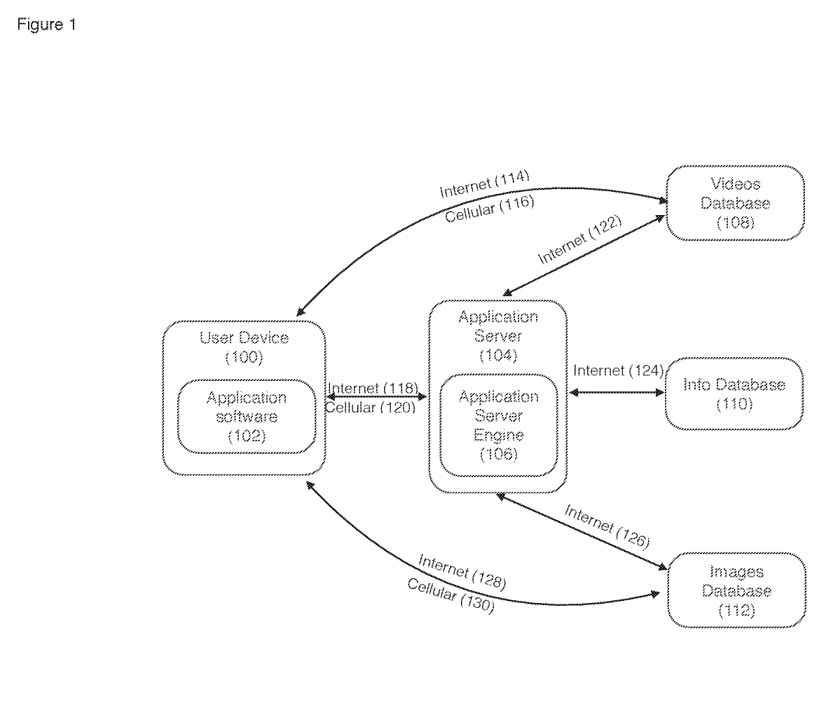

FIG. 1 shows a non-limiting example of a system for sharing and manipulating image data according to at least some embodiments of the present invention. As shown, there is a user device 100 operating an application software 102, communicating with an application server 104, a video database 108 and an images database 112 through any available means of communication, shown as an Internet connection 114 or a cellular connection 116.

Application server 104 operations an application server engine; application server 104 also communicates with an informational database 110 through an internet connection 124. In addition, application server 104 also communicates with video database 108 through an internet connection 122 and communicates with images database 112 through an internet connection 126.

Application software 102 preferably manipulates image data, optionally including video data, as described in greater detail below, and then shares such manipulated image data with videos database 108, images database 112 and application server 104. Application server 104 is preferably responsible for authentication and other activities which relate to communication with the various database, for example in order to share the manipulated image data outside of user device 100. As a non-limiting example, such sharing could be performed through a social network, in which the operator of user device 100 (the user) could optionally have a profile with specific profile information. Preferably such sharing is controlled through application server 104 and is stored in info database 110. For example, the user profile could optionally be stored in info database 110, along with a list of addresses to images and videos that are associated with that profile. In this exemplary implementation, videos database 108 would store the actual videos and images database 112 would store the actual images. After user device 100 receives from application server 104 the addresses of the images and videos of the associated profile, the actual content would be retrieved from videos database 108 and/or images database 112.

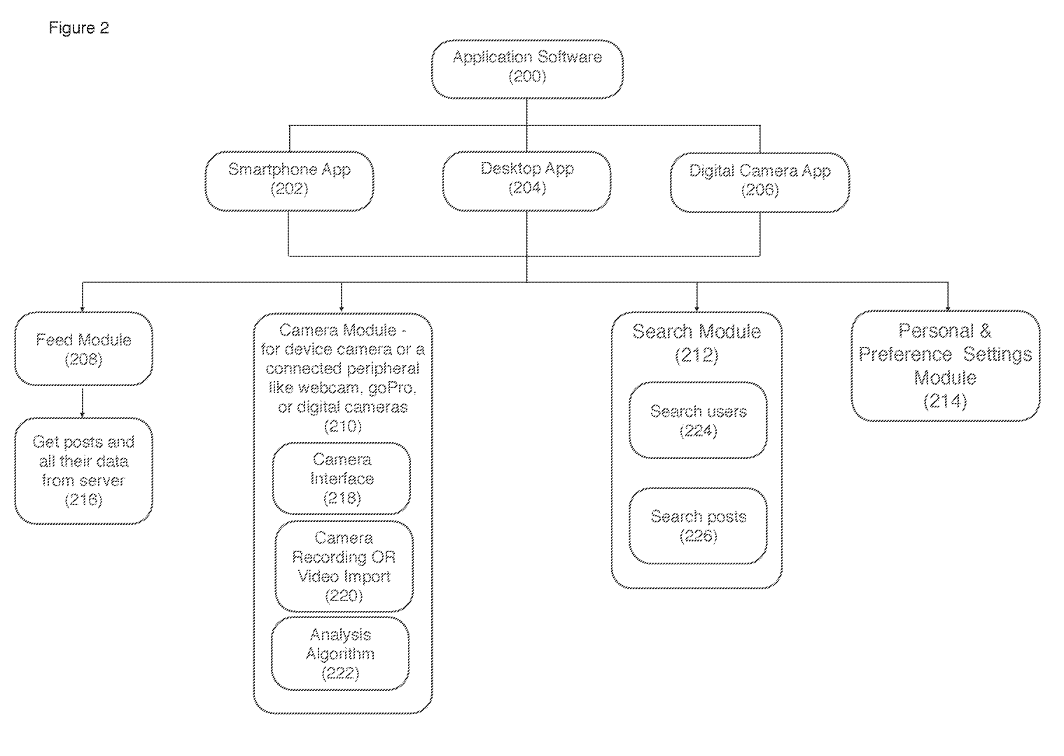

FIG. 2 is an exemplary non-limiting implementation of internal modules of application software 102 according to at least some embodiments of the present invention. These modules are shown in an overall organizational structure of an application software 200, which may optionally be operated by one or more of a plurality of devices, which could optionally be a smartphone or a desktop or a digital camera, and each would have its own application version, but preferably sharing similar or the same modular structure and also the same or similar functional options. For example, a smartphone would be any Smartphone, including but not limited to iPhone, Android, or Windows phone or whatever. Desktop could optionally include any operating system or hardware, including but not limited to Apple, Windows or Linux. In any case, preferably smartphone app 202, the desktop app 204, and the digital camera app 206 all need to be run on platforms that can support all of the below modules.

The below modules include a feed module 208, a camera module 210, a search module 212 and a preference module 214. Feed module 208 would be responsible for getting posts, similar to Facebook feed or Instagram feed, and would get the posts of the people or the users that the user is following, including their username, their profile pictures, and some analytics from the post; for example, how many people liked that post and how many people commented on that post and when that post was actually published. Feed module 208 obtains the posts and their data from the application server. Feed module 208 would communicate with application server 102 through an interface 216 to get the basic post information, which would be user's profile picture, username, how many likes, how many comments, when that post was actually published, and the description of that post as well as the address of the image or video itself, which in return, that feed module would communicate with the videos database 108 or the images database 112 to actually download and stream the video or image.

Next, camera module 208 opens to camera interface 216, which is used to start recording and performing the video and image data manipulations as described herein, such as light painting for example. The camera module 210 makes use of the built-in camera of the device, or a connected camera (whether connected wirelessly or by a cable), to record. Camera recording/import module 220 is used to record or import video. An analysis module 220 is used for analyzing the video or the input. For example, analysis module 222 analyzes the frames of video to be able to keep track of the light strokes and other video parameters, which are needed for manipulations of the video and image data as described below.

Camera module 210 communicates with the camera on any of the devices described herein as a platform. Optionally, for certain platforms, such as smartphone app 202 and desktop app 204, camera module 208 can also interact with a local storage for video and/or image data, such as a “gallery” or other local device storage. Such data is passed to application software 200 through camera recording/import module 220.

A search module 212 has two sub-modules. A first sub-module 224 is used to search for users while a second sub-module 226 is used to search for posts. Either sub-module can send a keyword query to the application server 104, and the application server 104 would do a query on the info database 110 with regard to the keyword or keywords. Personal and preference settings module 214 optionally includes static camera settings that handles that camera interface 218 and some notifications, which would in return communicate with the application server 104 to get the recent activities of the user account, for example in regard to liked or commented posts, or suggested people to follow.

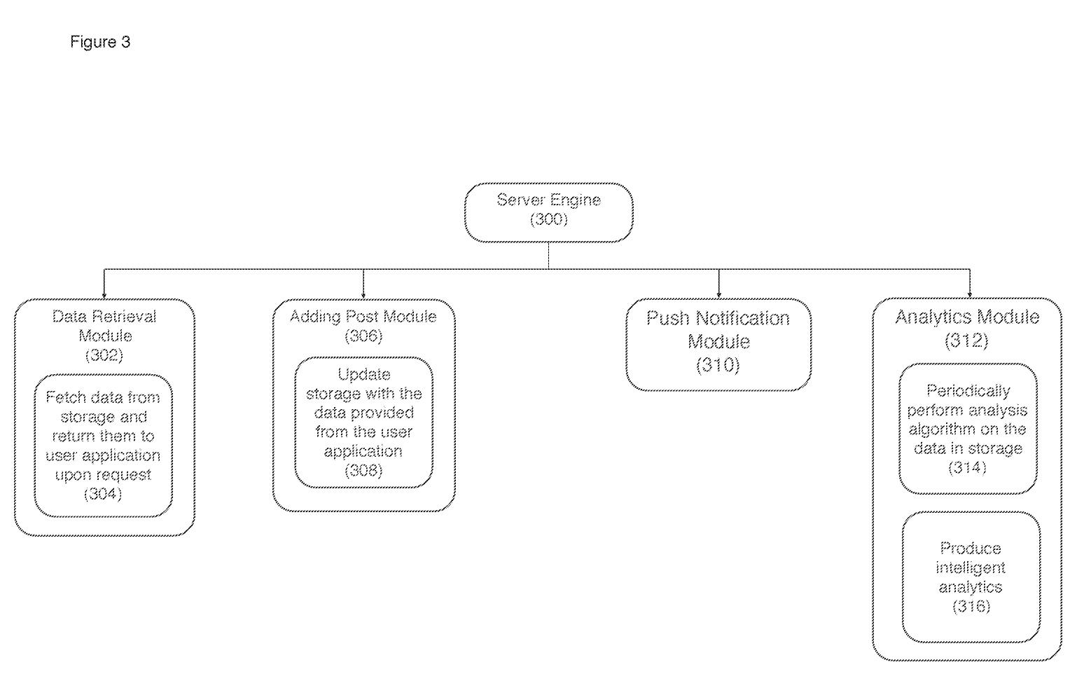

FIG. 3 shows the different components of server engine 300 which is being run on application server 104. Server engine 300 is responsible for different modules in the application, including a data retrieval 302, which queries information database 110 and returns this information back to the user device (not shown) through an interface 304. Adding post module 306 gets information from the user device (not shown) and, using this information, updates the video database 108, info database 110, and image database 112.

The next module is push notifications module 310, which according to the interactions done by and through the user device (not shown) and/or the server engine, sends out a push notification to other users based on the nature of the interaction. Analytics module 312 is for analyzing and keeping track first of the interactions made by each user using the user device. Module 314 is responsible for receiving diagnostic information as the user interacts with the app, including but not limited to, for example, how often a user posts a new video or image, how many new posts are shared on external social networks through the application. Module 316 is for running analytics and producing reports from these numbers and sends them to the Marketing and Innovation teams.

Analytics module 312 keeps track of the trends with regard to users: how many active users per week, month, year and so forth. A simple report could for example optionally show which day of the week has the most user interaction. Analytics module 312 also keeps track of user engagement by a post: how many posts the user downloads, how many posts the user uploads, unfinished posts; and optionally also user behavior to log into the software (for example, logins through Facebook or other social media identifiers, or by password).

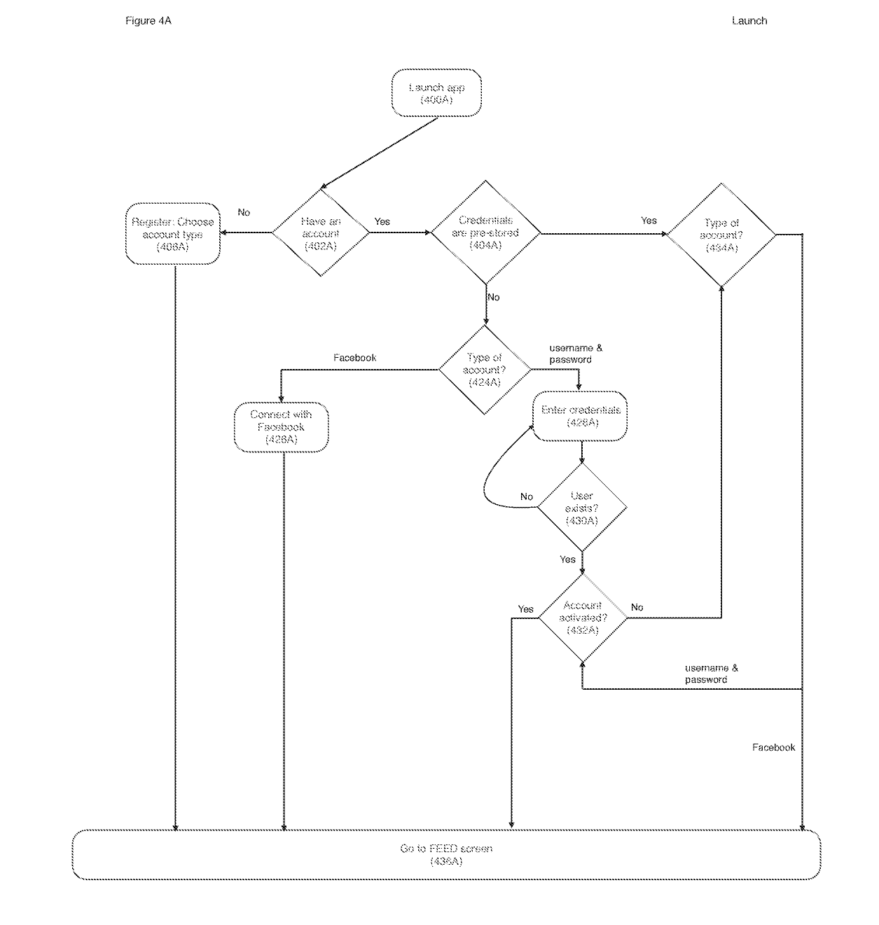

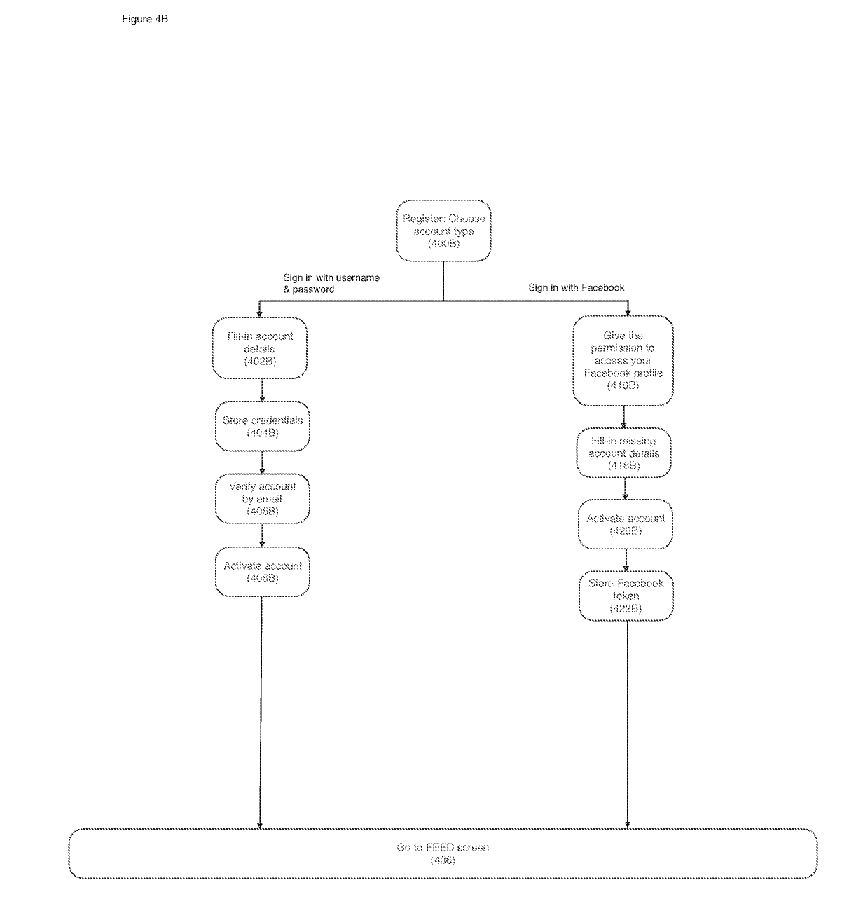

FIGS. 4A and 4B show together a non-limiting exemplary process which describes what happens at launch of the app (software according to at least some embodiments of the present invention). This could also include the first time the app is launched.

The process starts by launching the app, stage 400A. Stage 402A would be a decision of whether a user has an existing account or not. If the user already has an account, the process proceeds to stage 404A, to check whether credentials are stored on the local device. If there are credentials pre-stored, the process proceeds to stage 434A, to check whether the login credentials are through a Facebook account or other social media account. If so, the process continues at stage 436A to go to the feed screen.

If it's a username and password account, the process proceeds to stage 432A to check if this account is activated or not. If it's activated, the process proceeds to stage 436A as above. If it's not activated, the process proceeds to stage 434A, to either request different credentials or to create an account (or to activate a created account).

In FIG. 4B, in stage 400B, if there aren't any credentials stored, then the user is asked to register in stage 402B. At this stage, the user can connect with Facebook in stage 410B to register. In this stage the user performs the Facebook authentication process of giving permission to the app to access the user's Facebook information. Then, the process proceeds to stage 418B, where the user completes registration details. Then the process proceeds to stage 420B, where the account gets activated instantly, and the application stores the Facebook credentials, in stage 422B. Then, the process proceeds to stage 436B.

Alternatively, if the user chooses to register as a username and password account, the process proceeds to stage 402B, where the user enters all the information. The user credentials are stored in stage 404B. Then, stage 408B is email verification, which is done outside the app. Once that is done, the user account is activated in stage 410B, and the process proceeds to stage 436B.

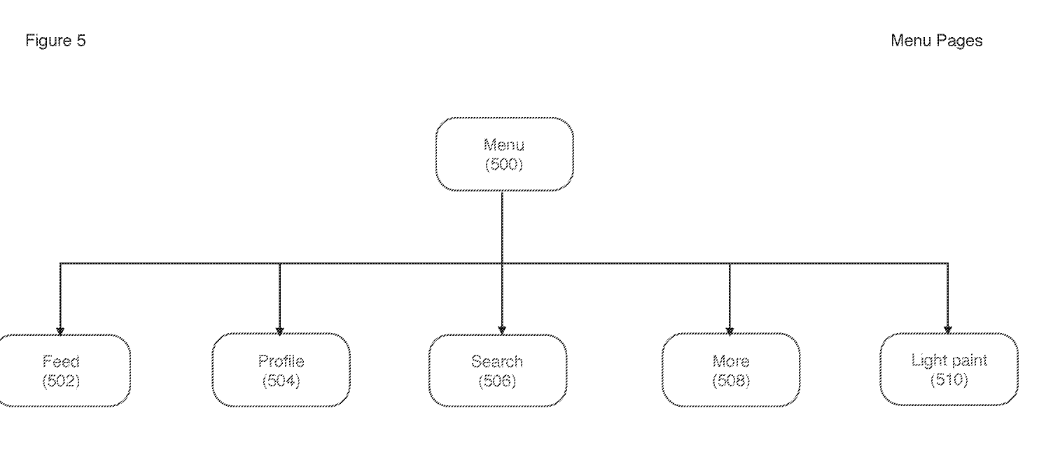

FIG. 5 shows an exemplary non-limiting menu 500, featuring the main menu pages in the application. First is the feed screen 502, which is referenced in FIG. 4; a profile screen 504; a search screen 506, to search users or posts, as discussed in FIG. 3. A “more” screen 508 preferably has the settings preferences of the user, whether camera preferences or personal preferences. Then, the light painting screen 510, which is operated by the camera module (not shown) and which provides the user interface to manipulate the video or image data.

In light painting screen 510, the user will put in inputs for such video or image data manipulation, which will communicate then directly with the camera module 208, in FIG. 2.

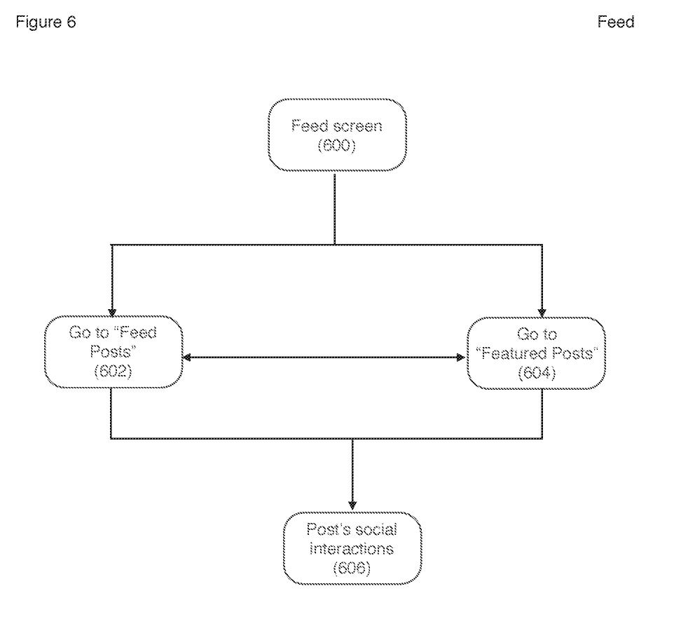

FIG. 6 is the feed screen 600. It has two options. The user can go to the feed posts, 602, which are the posts of the people the user are following, and from that, the user can switch to 604 which is the featured posts. The latter can be described as an editor's choice of posts that are popular for some metric either based on personal judgment or an algorithm. From either page, you can interact with the posts themselves. From either screen (page), entry may be made to post social interaction 606, where the user can comment, like and so forth on posts, as well as to see other user profiles.

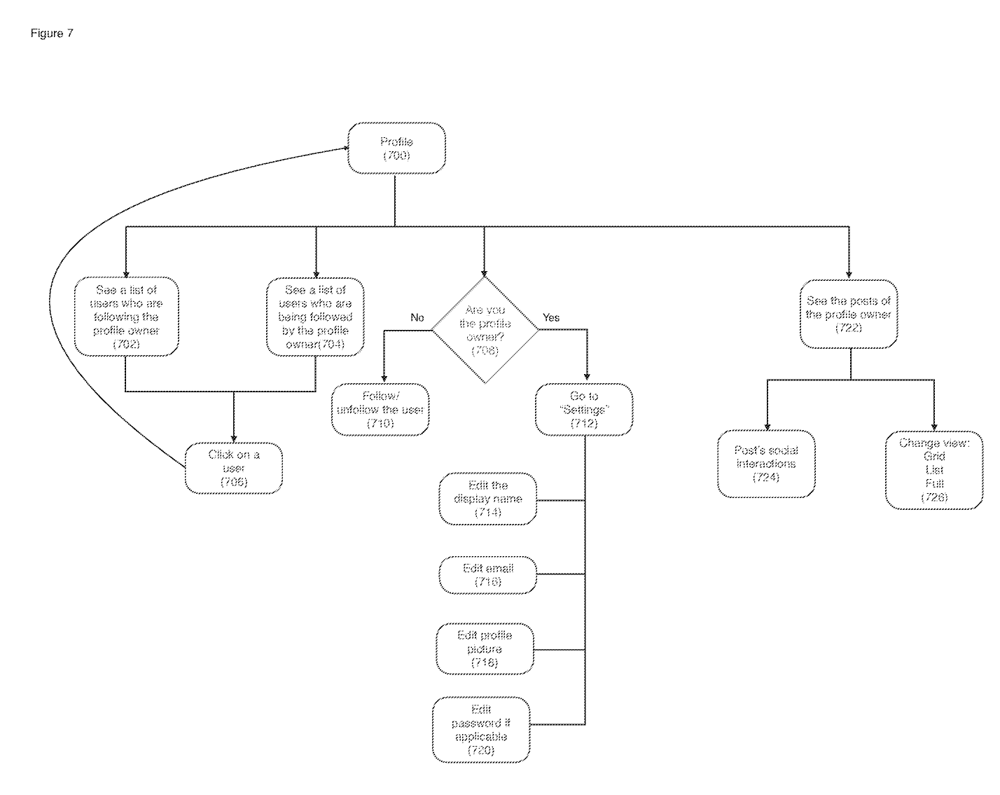

In FIG. 7, the user is able to view the user profile of the user or another user, starting in stage 700. In stage 702, the user can see the list of users who are following the profile owner. If the user clicks on one of these other users, then in stage 706 the process returns to stage 700 for that selected user profile. In stage 704, the user can see a list of users being followed by the profile owner, which again can continue to stage 706.

In stage 708, the process determines whether the viewing user is the profile owner. If so, in stage 712, the user enters an editing mode, for example to edit the display name (stage 714), the email address (stage 716), the profile picture (stage 718) and optionally the password (stage 720).

If however the user is not the owner, then in stage 710 the user can choose to follow or unfollow the profile owner.

In stage 722, the user can see the list of posts of the profile owner, including the images or videos that that user posted. The user can socially interact with a post, in stage 724. In stage 726 the user can choose how to view these posts, for example as a grid, list or full scaled post view.

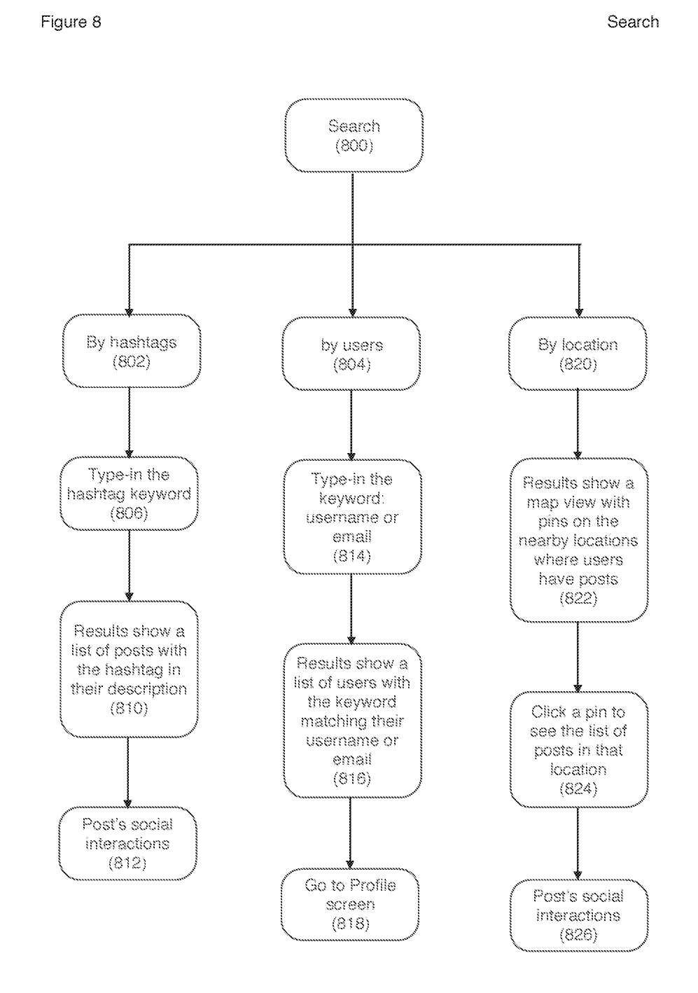

FIG. 8 shows an exemplary non-limiting search screen and process. The search starts in stage 800, and the user can choose to search by hashtags or users or locations. In stage 802, the user searches by hashtags by entering one or more hashtags in stage 806; the results show a list of posts with the hashtag in their description in stage 810. For each post, the user can again interact with them in stage 812.

If the user chooses to search for other users, in stage 804, the user can type in the username or email in stage 814. The results show a list of users in stage 816. In stage 818, the user can click on that specific search result, that user, and the process continues to display their profile screen (see FIG. 7). If the user searches by location, in stage 820, the results would show a list of posts that were taken in this specific location in stage 822. The user can socially interact with that post in stage 826.

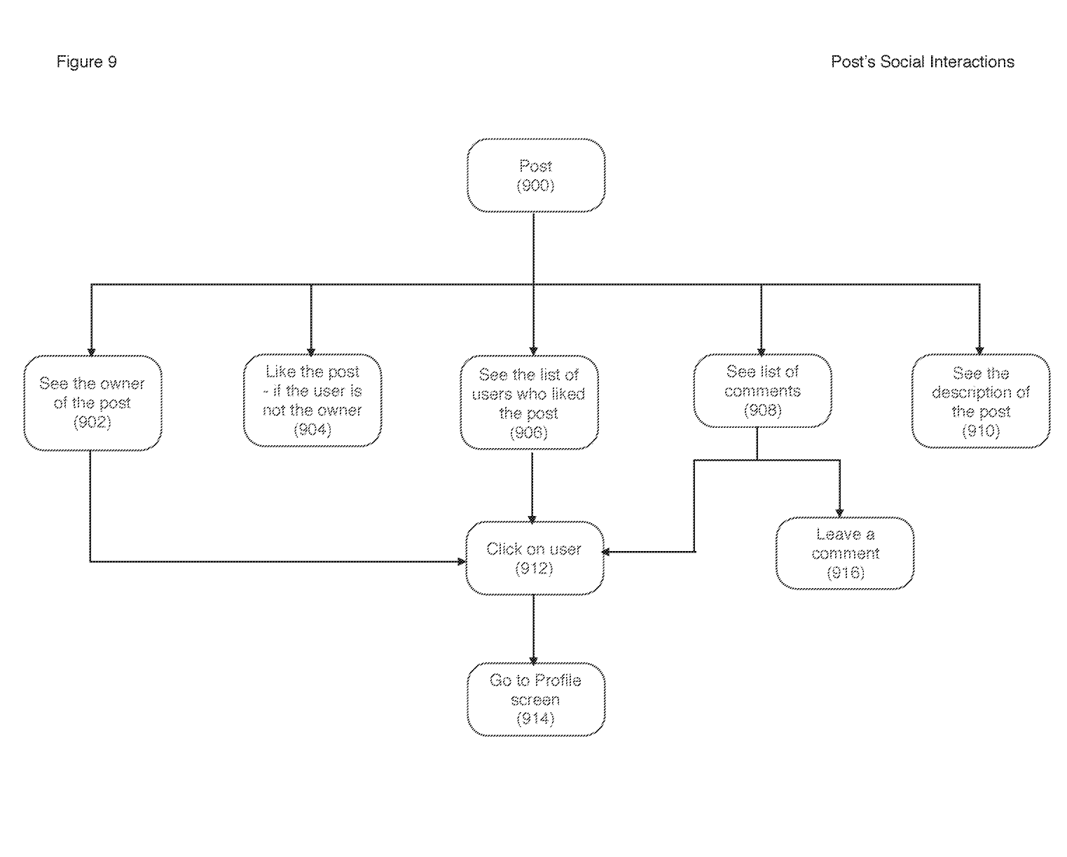

FIG. 9 explains the social interactions in more detail. A post is viewed in stage 900. The user can see the owner of the post in stage 902. When user clicks on the profile owner in stage 912, the user is taken straight to their profile screen in stage 914. In stage 904, if the user is not the owner of the post, then the user can like the post in stage 904, see a list of comments in stage 908 (and optionally leave a comment in stage 916), and see a description of the post in stage 910.

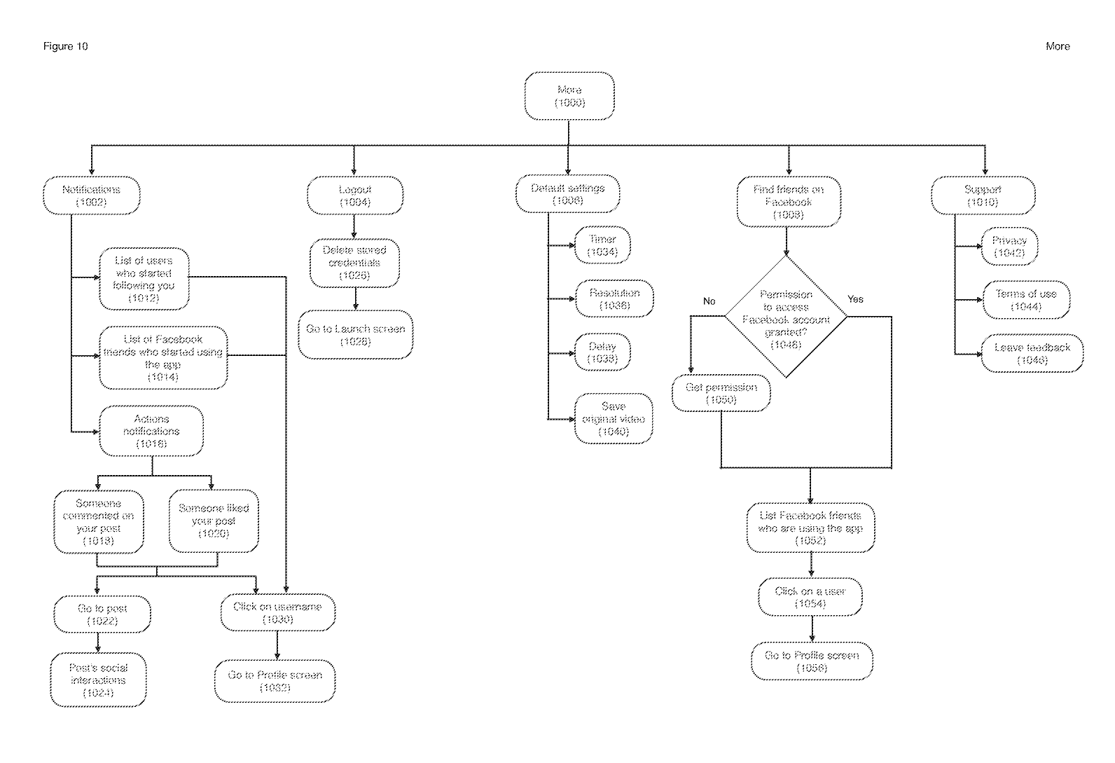

FIG. 10 shows a non-limiting example of the More screen, which has more preferences and settings. The process starts with the main screen in stage 1000. The user can see the notifications, 1002. The notifications consist of three main subcategories. The first one, 1012, is the list of users who started following that user, and 1014 is the list of Facebook friends who are using the application. Stage 1016 are the action notifications. Action notifications are split into two categories, which are given in stage 1018, that someone commented on the user's post, and in stage 1020, which someone liked the user's post. Then, the user clicks on that notification, after which the user can either click on the post itself or the username of the person who did that action. Stage 1022 would be clicking on the post. The user would go to that post and start one or more social interactions, in stage 1024, or click on the username, which is stage 1030. The latter action would bring the user to their profile screen, 1032. The first two categories of notifications, shown in stages 1012 and 1014, also enable the user to click on the username in that category, bringing the user to 1030, which in turn leads to stage 1032, to their profile.

Returning to stage 100, the user can log out, which is stage 1004. That deletes the stored credentials, 1026, and takes the user back to the launch screen, 1028, the launch screen which is shown in FIG. 4. Stage 1006 shows default settings, including preset camera settings like a timer, stage 1034, resolution, stage 1036, delay timer, stage 1038, and an option to save the original video or not in stage 1040. These settings are related to the video manipulation aspects of the app for manipulating and changing the video data.

The full settings in stage 1006, specifically manages the camera module discussed earlier. For example, the timer, which is in stage 1034, basically sets a time limit of the number of seconds the user is recording video, preferably as an upper limit. Resolution, stage 1036, gives the user the option to choose from the supported image and video resolutions, depending on the device itself, so that that would be the resolution of the recording of the camera that will be used. The delay, stage 1038, is preferably set in seconds. The user specifies the delay of the camera before the camera starts shooting, so if the delay is three seconds, and the user starts shooting, actual recording starts in three seconds. Saving the original video, stage 1040, is an on and off option. If it's on, the original video is saved in addition to the processed video; otherwise only the processed video is saved.

Back to the main level, in stage 1008 the user can find friends on Facebook. The app checks if it has permission to access Facebook information, which is stage 1048. If so, then the process continues with stage 1052, which accesses the user's basic information on Facebook and lists all the friends who are using the application in stage 1052. If a specific user is selected in stage 1054, the process continues with that user's profile screen, stage 1056. Back to stage 1048, it is determined whether there is permission to access Facebook information or not. If not, the user needs to perform the Facebook authentication process to get that permission, which is stage 1050, after which the above process is repeated to access the user information of Facebook contacts.

A support section is given in stage 1010. It consists of three stages to set options, including a privacy stage 1042 to explain the privacy issues of the app. Stage 1044 explains the terms and conditions of using the application. Stage 1046 is a way for users to leave feedback.

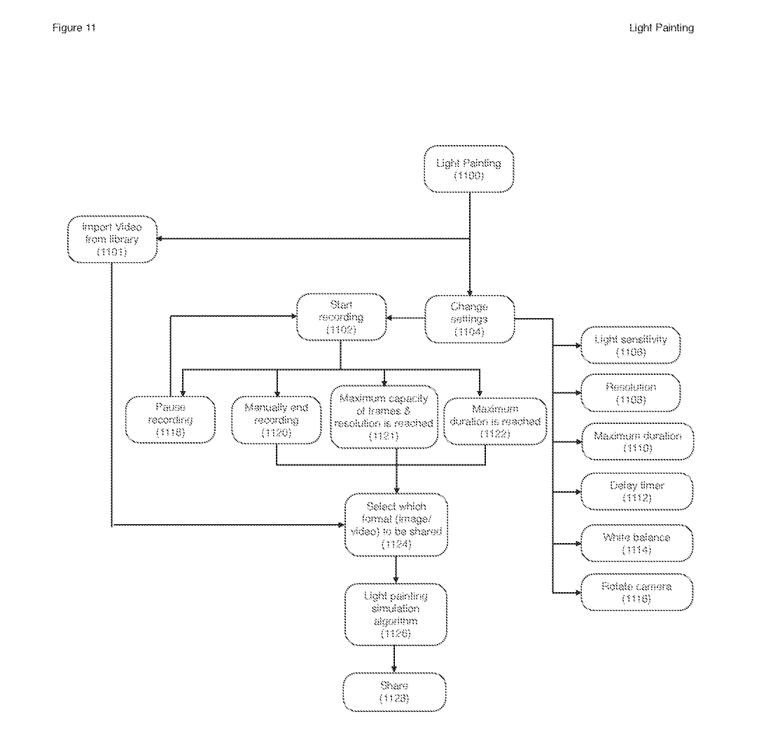

FIG. 11 is an exemplary non-limiting process that shows how light painting works from the point of view of the user, including actions taken by the user to light paint the video to manipulate that video data. FIG. 11 shows a screen overview of the user interaction as an example. The process starts with light painting screen, stage 1100. The user starts recording, stage 1102. The user can change the settings before recording in stage 1104. The settings that can be changed include but are not limited to light sensitivity, stage 1106, which is how sensitive the camera lens is to light; the resolution of the recording in stage 1108; the maximum duration, stage 1110; the delay timer, stage 1112; the white balance, stage 1114; and rotating the camera in stage 1116, to determine which camera lens to use because some phones have two cameras, back and front, so one needs to be selected.

Returning now to stage 1102, the user starts recording. The user can pause recording in 1118 and change something in the environment and continue recording again back to stage 1102, which may optionally be repeated as a loop. The user can pause and continue, pause and continue. The user can end the whole recording in stage 1120, or alternatively when the maximum duration is reached in stage 1122. In either case, the process continues in stage 1124, which asks the user to choose which format to share, image or video, in stage 1124. Then, the light painting simulation algorithm is performed in stage 1126, and then the user can share the final product in stage 1128. In addition to the maximum time duration, the process may optionally be stopped according to the amount of video data in stage 1121. The amount of data may optionally relate to the maximum capacity of frames and/or resolution. In this example, duration may optionally be determined according to the number of minutes of video, and/or the amount of data; the latter at least in part depends on the video quality, which in turn depends on the frame quality and, of course, the number of frames.

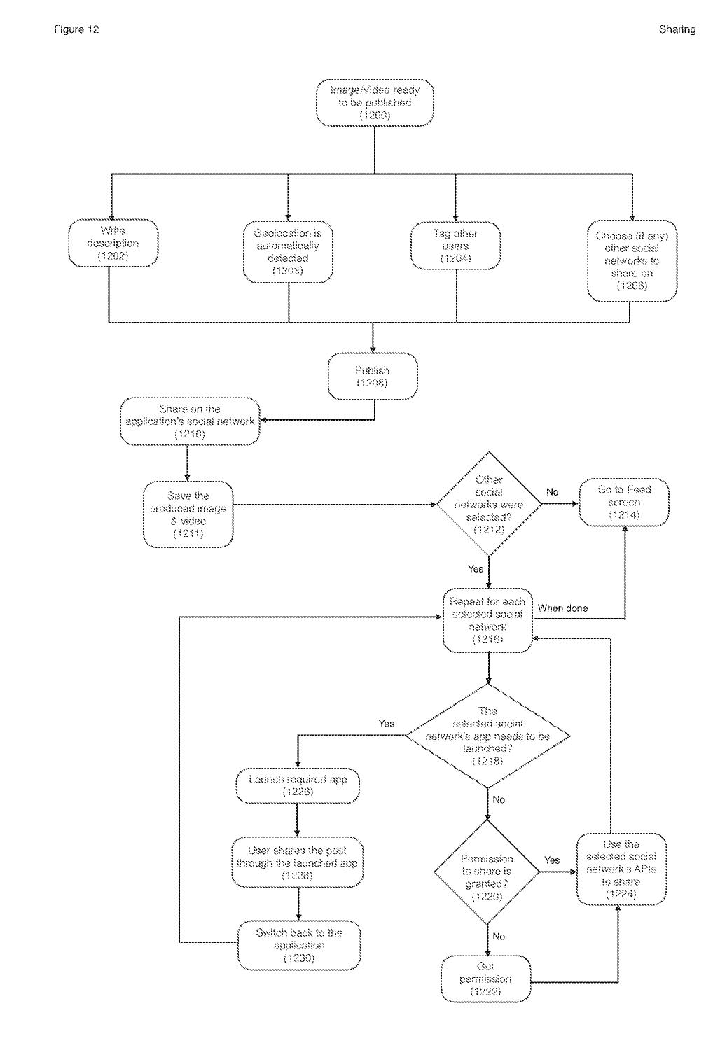

FIG. 12 is an exemplary non-limiting method for the last process in the camera module in which the image and/or video is prepared ready to be published. The process starts in stage 1200 in which the image is ready to be published. A description is written for the image in stage 1202. Geolocation is automatically detected, that is where the image and the video was prepared in stage 1203. Other users who may be present in the image or video are then optionally tagged in stage 1204. Also optionally in stage 1206, the user decides which if any other social networks to share the image or video on. In stage 1208, the image or video was published. In stage 1210, it is shared on the application's social network which is the social network for the present system. In stage 1211, the produced image and video are both saved to the storage as previously described.

In stage 1212, other social networks were selected. Then in stage 1216, the process is repeated for each social network. If this is finished or if no other social network are selected, then the process continues with the feed screen in stage 1214. Turning back now to stage 1216, for each social network that is selected the following process is performed. The selected social network's application or API needs to be launched in stage 1218. Stage 1220 checks if the permission to share is already granted. Permission is obtained in stage 1222 if it's not previously granted. If it was previously granted or if permission is then granted, in stage 1224 the selected social network's API is selected to share. The process then continues on with stage 1216. If the selected social network's effort needs to be launched, were turning now back to stage 1218, then the app is launched in stage 1226. The user shares the post through the launched app in stage 1228. The interface returns to the regular user interface for the present system in stage 1230. This process is optionally repeated from stage 1216 until the image or videos have been shared with each social network.

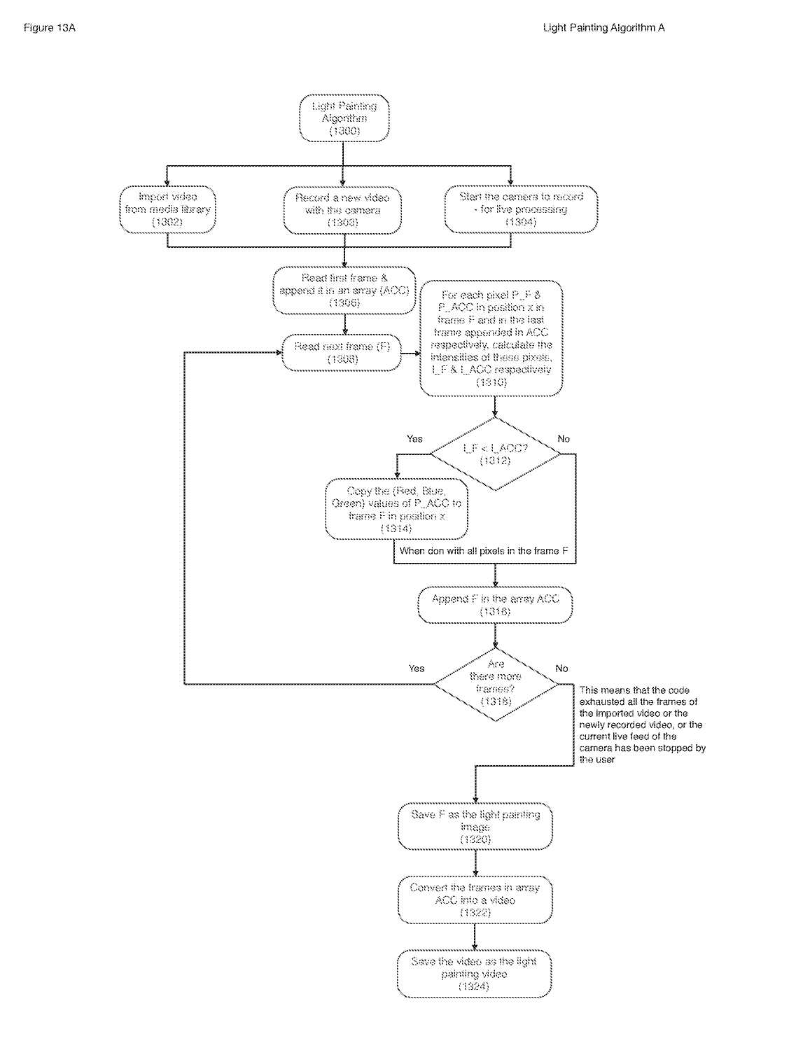

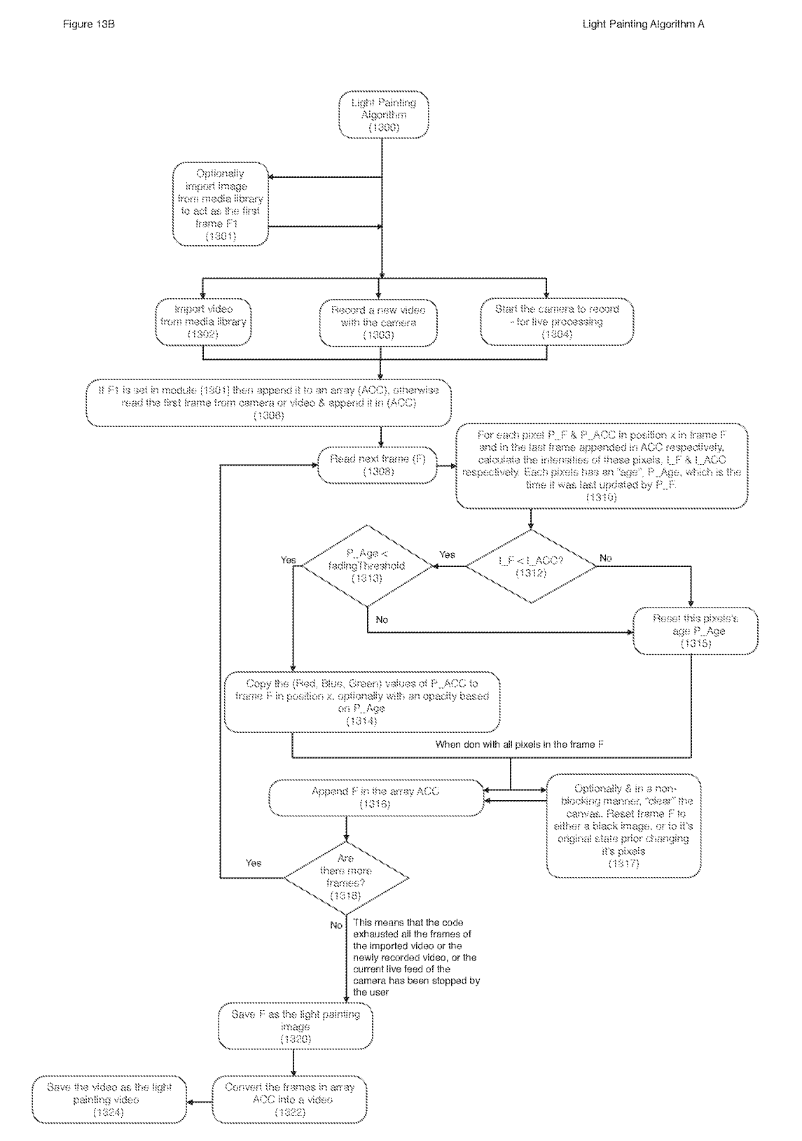

Turning now to FIG. 13A, there is shown an exemplary non-limiting method which shows how the light painting algorithm itself works. The process starts at stage 1300 in which the light painting algorithm is begun. In stage 1302, the videos are imported from the media library. This is the previously produced video. Alternatively in stage 1303, a new video is recorded with the camera. Also alternatively in stage 1304, the device camera begins to record the video for live processing. Optionally according to at least some embodiments, two or more of these stages maybe combined. It may optionally be possible to combine video that was previously recorded and video that is live recorded for example.

In any case, once the video is prepared or at least the process is starting to prepare the video in the case of live processing, then the first frame of the video is read and appended in an array ACC in stage 1306. The next frame F is then read in stage 1308. Each pixel is then read from a particular position x from each of frame F and the last appended frame in array ACC. Specifically each pixel P in F, that is P_F at position x, and each pixel P in the last appended frame in array ACC, which is to say P_ACC, in position x, is read. The intensities I of these pixels in position x (P_ACC and P_F) are calculated, such that the intensity of the pixel P_F or I_F is calculated, as is the intensity of the pixel P_ACC which is I_ACC, in stage 1310. Now in stage 1312, it is determined whether the intensity of the pixel in ACC, that is I_ACC, is greater than intensity of the pixel in frame F, or I_F; in other words it is determined whether I_ACC is greater than I_F.

If I_ACC is greater than I_F, then in stage 1314 the values of the pixel in the last frame in ACC at position x (P_ACC) are copied to frame F in position x, thereby replacing the previous values of P_F with P_ACC. These values may for example be red, blue, green, but in any case these values in whatever format are copied to frame F in position x, thereby completing stage 1314. This process is then optionally and preferably repeated for each pixel in frame F. Once all the pixels in frame F have been processed, then frame F is appended in the array ACC in stage 1316. If there are more frames to be processed in stage 1318, then the process goes back to stage 1308 and the next frame is taken. If not, this means that the process has exhausted all the frames of the imported video, or the newly recorded video, and/or the current live feed of the cameras has been stopped by the user. In other words, there are no more frames left for processing.

In stage 1320, the last frame which has been processed is saved as the light painting image. In stage 1322, the frames in the array ACC are converted into a video. Alternatively, the frames in the array ACC are appended to a newly created video and each time a new frame is processed, it is directly appended to the video. This way, the light painting video is created and then updated with each frame, and not created at the end of the processing. As previously described, each frame which is processed is appended into the array ACC after processing. The array ACC is now full of frames that had been processed. Now these frames in ACC are converted into a video. In stage 1324, the video is stored as the light painting video. As previously described, the last frame after this had been processed is saved as a light painting image. Each of the light painting image and the light painting video may optionally be shared separately, further processed separately, transmitted separately, and/or stored separately.

Overall, the process operates as follows for the method in FIG. 13A. To start this process, two frames are taken from F. The first frame is compared to the second frame. Pixels with higher intensity are saved in the second frame; both frames are stored in the ACC (although optionally only the second frame is stored). The process continues so that if the pixels in the last frame appended to the ACC are brighter, their values are saved; if the pixels are brighter in the comparison frame from F, then those values are saved.

The ACC contains a plurality of separate frames, but each such frame represents an accumulative history of the brightest pixels in the video up until that point. The very last frame represents the light painting image which could either be a separate image could be shared or thumbnail for the light painting video. Because of the representation of the accumulated history in the ACC, there is a limit to the amount of data which can be stored, whether that limitation is by size of the data, number of frames, the amount of time that the video recording represents or some such limitation. This processing limitation may optionally depend upon the system, may optionally be determined by the user, or some combination thereof. Optionally and preferably, there is some type of buffer counter system which would prevent the ACC from getting too large for processing.

FIG. 13B shows a similar method to FIG. 13A, except that in stage 1301, an image is imported from a media library to serve as the first image. Stage 1306 is similarly adjusted if necessary in regard to frame F1. Each frame is read in stage 1308. In stage 1310, for each pixel P_F & P_ACC in position x in frame F, and in the last frame appended in ACC respectively, the intensities of these pixels, I_F & I_ACC, respectively are calculated. Each pixel has an “age”, P_Age, which is the time it was last updated by P_F.

Stage 1312 is performed as previously described. Now in stage 1313, if P_Age<fadingThreshold, then in stage 1314, copy the (Red, Blue, Green) values of P_ACC to frame F in position x, optionally with an opacity based on P_Age. Alternatively, in stage 1315, reset this pixels's age P_Age. The remaining process proceeds similarly to that previously described.

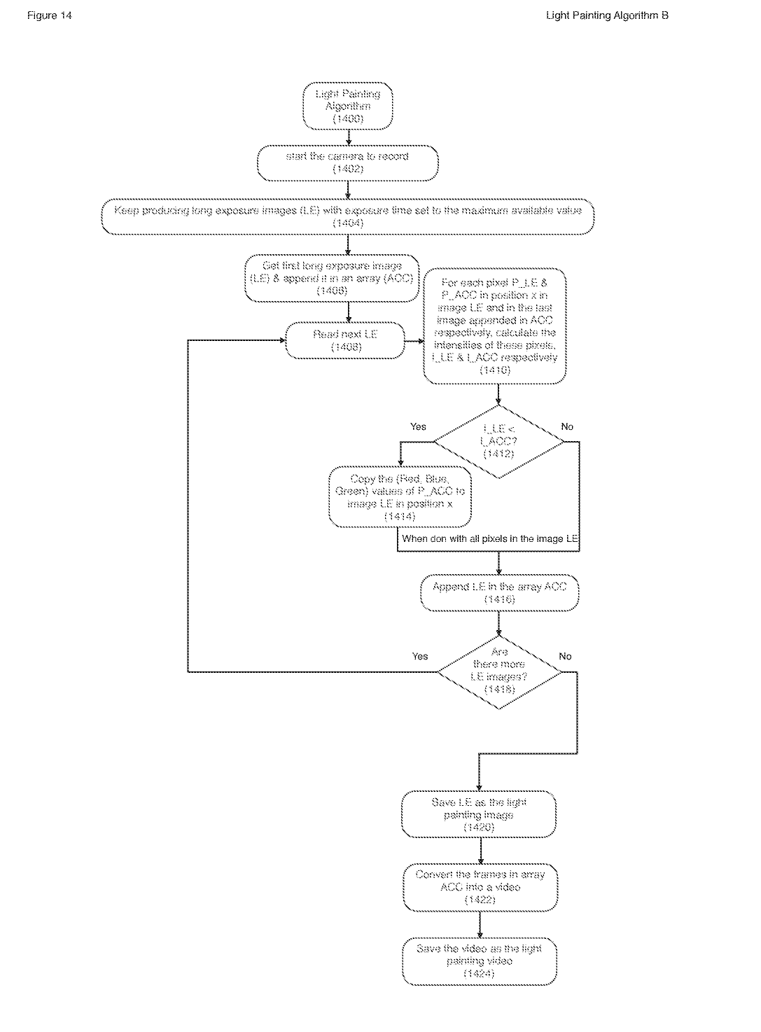

FIG. 14 shows a different version of the light painting algorithm in an exemplary non-limiting embodiment according to the present invention. This method starts with stage 1400. The device camera starts to record in stage 1402. In stage 1404, long exposure images are produced which are termed here LE with an exposure time such as high value option preferably even the maximum available time. In stage 1406, the first long exposure image LE is retrieved and is appended to an array ACC. Then the next LE is read in stage 1408. For each pixel in position x in LE, P_LE, and each pixel in position x in the last appended frame in ACC, P_ACC, the intensities of these pixels I are calculated. Now, the intensity of the pixel in the particular position in LE, which is I_LE, is compared for the pixel in the same position in the frame in ACC, which is I_ACC, in stage 1410.

Next in stage 1412 is determined whether I_LE, that is to say the intensity of the pixel in LE, is less than I_ACC, which is the intensity of the pixel in ACC. If so, then the values of the pixel in ACC are copied to image LE in position x in stage 1414; these values may for example optionally be red, green, blue, and yellow values. If the intensity is not greater, then this does not occur. When all pixels are then finished in the image LE, the LE is appended to the array ACC in stage 1416. If there are more LE images, then in stage 1418 it returns back to stage 1408 to continue with the next LE. If there are no more LE images, then from stage 1418 it precedes to stage 1420 where the LE is saved as light painting image. This is of course the last image which has been prepared. The frames in area ACC are converted to a video in stage 1482 as previously described, and the video is saved as light painting video in stage 1424. Otherwise this is a similar algorithm to that described in FIG. 13 and the light painting image and with the light painting video may optionally be further processed, may optionally be stored, may optionally be combined with other information, and/or may optionally be stored or shared as previously described.

What is claimed is:

1. A system for video processing in which video data is manipulated to provide an aesthetic effect, comprising a user device and a user device software for being operated by the user device, wherein the user device software manipulates video data according to a comparison of pixels across a plurality of frames of said video data, wherein pixels having at least one characteristic are written to a plurality of frames of manipulated video data.

2. The system of claim 1, wherein the user device software manipulates video data by comparing each pixel in each frame to a previous frame, and writing a pixel having said at least one characteristic to a greater extent to a cumulative frame, such that said plurality of frames of manipulated video data comprise a plurality of cumulative frames.

3. The system of claim 2, wherein said at least one characteristic comprises intensity such that a pixel having a greater intensity is written to said cumulative frame; and wherein said comparing each pixel in each frame to said previous frame comprises comparing each pixel in each frame to said cumulative frame.

4. The system of claim 3, further comprising a plurality of additional user devices, a video server and video server software operated by said video server, wherein said manipulated video data is uploaded to said video server from the user device and distributed by said video server software to said plurality of additional user devices, thereby forming a social network.

5. The system of claim 4, wherein the user device software of a first user device indicates a user device software of a second user device, such that the user device software of said first user device receives a push notice when the user device software of said second user device uploads said manipulated video data.

6. The system of claim 4, wherein the user device software of the user device receives a notification when another user device software of another user device posts a comment or a like for said manipulated video data uploaded by the user device software of the user device.

7. The system of claim 3, further comprising an external social network, wherein said manipulated video data is uploaded to said external social network from the user device.

8. The system of claim 7, wherein said external social network is selected from the group consisting of Facebook, Instagram, YouTube, Vimeo and Twitter, and wherein said manipulated video data is uploaded automatically to said external social network.

9. A method for video processing, performed by a user device, the user device comprising a processor, comprising manipulating video data to provide an aesthetic effect, the processor performing the following steps:
a. Comparing a characteristic of a pixel Pa of frame a to pixel Pb of frame b;
b. If said characteristic of Pa fulfills at least one rule, writing Pa to a location of Pb in frame b to form a manipulated frame;
c. Repeating steps a and b for at least a plurality of frames of said video data.

10. The method of claim 9, wherein step b comprises determining whether said characteristic of Pa fulfills said at least one rule to a greater extent than said characteristic of Pb.

11. The method of claim 10, wherein said characteristic is selected from the group consisting of intensity, pixel component value or a combination thereof.

12. The method of claim 11, wherein said at least one rule relates to intensity, such that if said intensity of Pa is greater than said intensity of Pb, writing Pa to said location of Pb in frame b to form said manipulated frame.

13. The method of claim 12, wherein said frames of said video data are processed sequentially, further comprising combining said plurality of manipulated frames to form a manipulated video.

14. The method of claim 13, further comprising distributing said manipulated video through a social network.

15. The method of claim 14, wherein said social network is selected from the group consisting of Facebook, Instagram, YouTube, Vimeo and Twitter.

16. The method of claim 14, further comprising following a user identity on said social network through the user device and receiving a push notification of manipulated video uploaded according to said user identity.

17. The method of claim 13, wherein coordinates of pixel Pa in frame a are identical to coordinates of pixel Pb in frame b.

18. The method of claim 13, wherein said pixel component value is at least one of an R, G, B value.

19. The method of claim 13 wherein said user device comprises a mobile device, a cellular telephone, a smart watch, a smart phone, a laptop, a tablet or a computer.

20. The method of claim 13, wherein said user device controls a camera, the method further comprising obtaining video data through a long exposure process by said camera controlled by said user device.
